(19) United States
(12) Patent Application Publication
(10) Pub. No.: US 2003/0140951 A1
(43) Pub. Date: Jul. 31, 2003

(54) Wine barrel washing apparatus

(76) Inventor: Thomas E. Beard, Healdsburg, CA (US)

Correspondence Address: JOHNSON & STAINBROOK, LLP, 3550 Round Barn Blvd., Suite 203, Santa Rosa, CA, 95403, US

(21) Appl. No.: 10/353,585

(22) Filed: Jan. 28, 2003

Related U.S. Application Data
(60) Provisional application No. 60/353,054, filed on Jan. 29, 2002.

(51) Int. Cl. B08B 3/00

(52) U.S. Cl. 134/56 R; 134/144; 134/157; 134/158; 134/168 R

(57) ABSTRACT

An automatic wine barrel washing apparatus is disclosed. The apparatus includes a base portion having a plurality of horizontal and vertical support members, a top portion mounted on said base portion. The top portion comprises a plurality of spaced apart roller support plates, and a plurality of sinks disposed within the top portion. Each of the sinks include a drain and drain lines. Motorized wash tubes having heads are provided, each of wash tube heads adapted for insertion into a wine barrel through the wine barrel bung hole. The wash tubes are in fluid communication with a source of pressurized water. Wash tube elevation means selectively raise and lower the wash tubes, and wash tube rotating means rotate the wash heads during a wash cycle. A barrel wash cycle is controlled by a PLC or microprocessor.

### CROSS REFERENCE TO RELATED APPLICATIONS

The present application claims the benefit of the filing date of U.S. Provisional Application Serial No. 60/353,054, filed Jan. 29, 2002, which application is incorporated in its entirety by reference herein.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to barrel cleaning and sanitation devices, and more particularly to a modular wine barrel washing apparatus for use in cleaning 60 to 70 gallon oak and stainless steel barrels used for wine aging.

### BACKGROUND INFORMATION AND DISCUSSION OF RELATED ART

It is a long-standing problem to satisfactorily clean the interior surfaces of wine barrels so that they can be refilled and reused for aging wine. Automated barrel cleaning calls for the design of a machine that will thoroughly clean barrel interiors through the bunghole and without the use of chemicals. Because wine making is now an international art, employing thousands of workers of varying skill, a suitable cleaning apparatus must be easy to package and ship to foreign countries for assembly and use by semi-skilled workers. The machine must further work in harmony with barrel pallet racks, commonly used in the wine industry, and be loaded and unloaded by forklift.

In use, environmental concerns now dictate that the machine must accomplish a thorough cleaning with a minimum amount of water usage. Furthermore, the machine must be easily transportable throughout the winery, and it must be easy to maintain.

A few prior art devices are adapted for use in cleaning wine barrels. Some have encompassed a few of the goals in the above description, but none have successfully achieved all of them. The majority of the prior art devices utilize a free spinning spray head, which rely on pump pressure to maintain rotary motion. These spray heads are quite susceptible to temperature changes, and therefore must be machined to very loose tolerances in order not to seize when heated. The result is a very fast spinning action, which dissipates impingement energy and uses too much water due to leaking bearings. The excessive water collects, or ponds, in the lower portion of the barrel, thus allowing particulates and other solids to stagnate and resist passage to and through bunghole. Other attempts have involved pressure washer technology, which employs very low water flow and high pressure. These systems do not provide satisfactory cleaning results due to insufficient water flow and lack of “sheeting action,” which is necessary to carry solids out of the bunghole. Additionally, both of these systems are typically mounted on frames, or are housed in cabinets, which are overly complex, impede maintenance access, and require skill in effecting assembly and construction.

Related art in the field of beer keg cleaning devices includes U.S. Pat. No. 4,457,324, to Shepper, which discloses an apparatus for cleaning of barrel type containers, particularly beer kegs which have a fitting including a riser pipe which extends into the keg. The cleaning is accomplished by incrementally increasing the level of a cleaning liquid which has been introduced into the barrel and, between each step of injection of cleaning fluid, causing turbulent motion of the liquid in the barrel by means of the injection of preselected volumes of a gaseous medium at a point below the surface level of the liquid cleaning fluid.

An earlier beer keg cleaning apparatus is disclosed in U.S. Pat. No. 3,564,584, to Ruddick. This patent teaches a machine for washing beer kegs and similar containers, comprising a head which is arranged to be applied to the bung hole or other opening of the container, and which has an inlet passage for the supply of washing liquid to the container and for the supply of steam or gas under pressure, and an outlet passage out of which liquid or gas supplied to the container is blown by the steam or gas, the supply of liquid and gas or steam and other operations of the machine being controlled by a control device. The control device is connected to a liquid detector which is in communication with the outlet passage, such that after the supply of washing liquid and the subsequent supply of gas or steam, the detector causes the control device to initiate a further operation of the machine only when the detector detects the absence of washing liquid in the outlet passage.

While the above-described patents generally teach devices suitable for beer keg cleaning, neither disclose an effective and efficient wine barrel washing apparatus. Wine barrels differ significantly from beer kegs, both in construction and function. Beer kegs are constructed of stainless steel. A permanent stainless steel lance is mounted in the keg at the bung hole. The lance comprises a cylinder which extends nearly to the end of the keg opposite the bung hole. The lance is used to fill the keg, top-off the keg, and clean the keg after emptying.

By contrast, wine barrels are constructed of oak staves held together with metal rings. There are no internally mounted components which can be used to support a wash nozzle such as is incorporated in the above-described lance (see U.S. Pat. No. 4,457,324 to Shepper). The emptying, washing and filling processes for wine barrels are accomplished using devices inserted into the barrels and retracted after the cleaning function is performed.

Traditionally, the washing process for wine barrels has been accomplished through the manual insertion of a stainless steel pipe attached to a flexible hose into the barrel. A wash head is attached at the end of the pipe. The wash head is either fixed or rotated mechanically by the flow of the washing solution.

### BRIEF SUMMARY OF THE INVENTION

The present invention is an improved wine barrel washing apparatus that utilizes modular construction and motorized wash heads that are introduced into the barrels through the bungholes via feed tubs. The inventive apparatus is described in greater detail below. Briefly summarized, the unique characteristics of the present invention are: (1) a frame of modular construction onto which two or four wine barrels on storage racks are placed by fork lift; (2) rollers incorporated in the modular frame used to roll the barrels bung hole down for washing; (3) wash heads which are inserted into the barrels by an operator-controlled air cylinder; (4) timed wash cycles controlled by a programmable logic computer (“PLC”); (5) effective cleaning by wash heads which are rotated by electric motors mounted at the base of the wash heads; (6) capture of wash water for disposal through sinks incorporated in the modular frame; and (7) automatic withdrawal of the wash heads at the conclusion of the wash cycles.

Accordingly, it is an object of the present invention to provide an improved modular wine barrel washing apparatus that is easy to pack, ship, and assemble.

It is another object of the present invention to provide an improved wine barrel cleaning apparatus that cleans a wine barrel using water only.

It is yet another object of the invention to provide an improved wine barrel cleaning apparatus that effectively cleans the interior surfaces of a wine barrel while allowing for thorough and complete drainage of cleaning water and wine residue.

The novel features characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trade-mark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

FIG. 1 is a is a perspective view of the improved wine barrel cleaner of the present invention;

FIG. 2 is a top view of the apparatus of FIG. 1;

FIG. 3 is a front view in elevation of the inventive apparatus; and

FIG. 4 right side view in elevation of the wine barrel washing apparatus of the present invention.

### DETAILED DESCRIPTION OF THE INVENTION

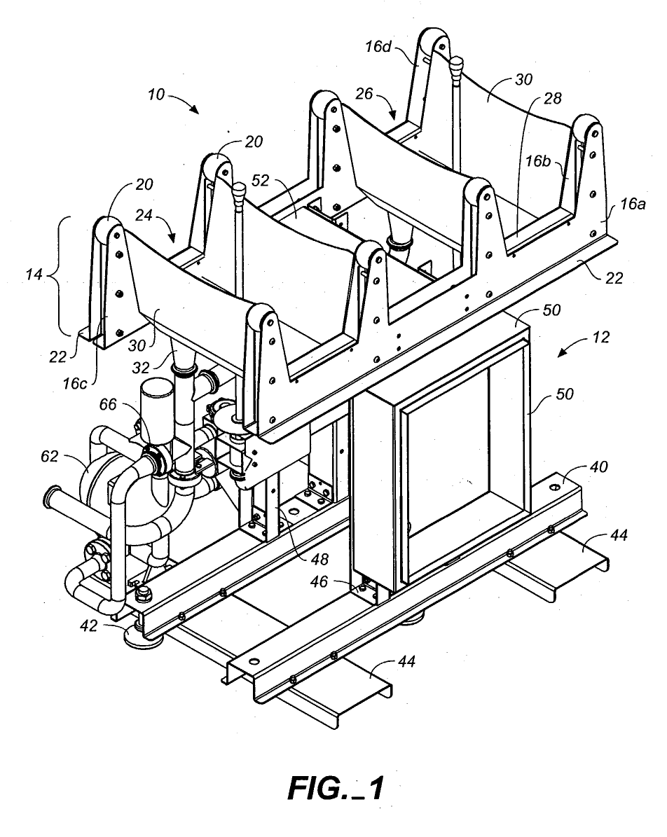

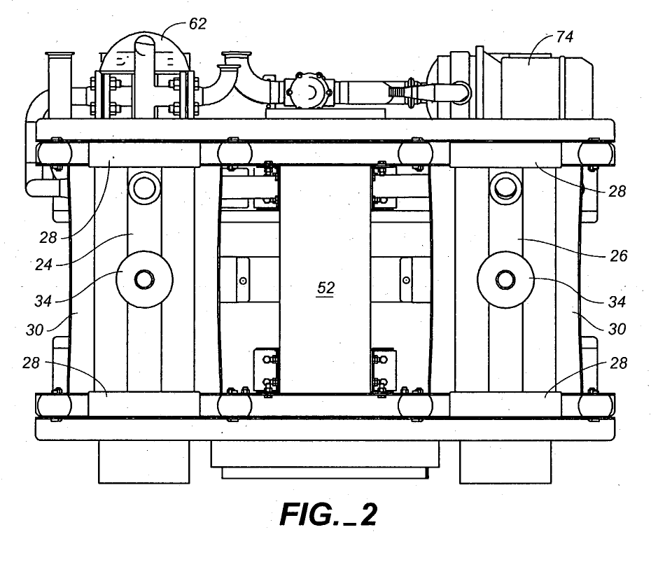

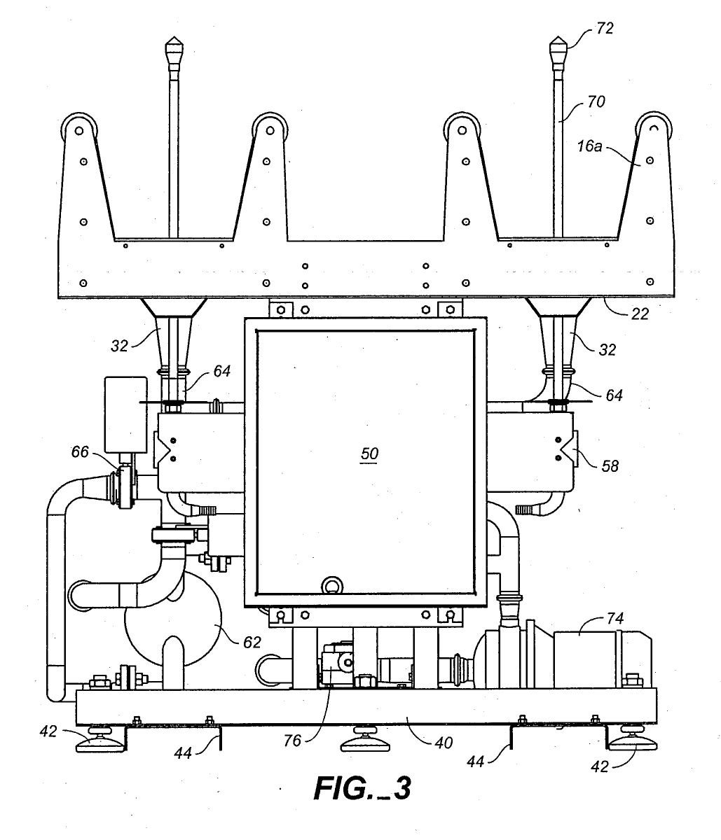

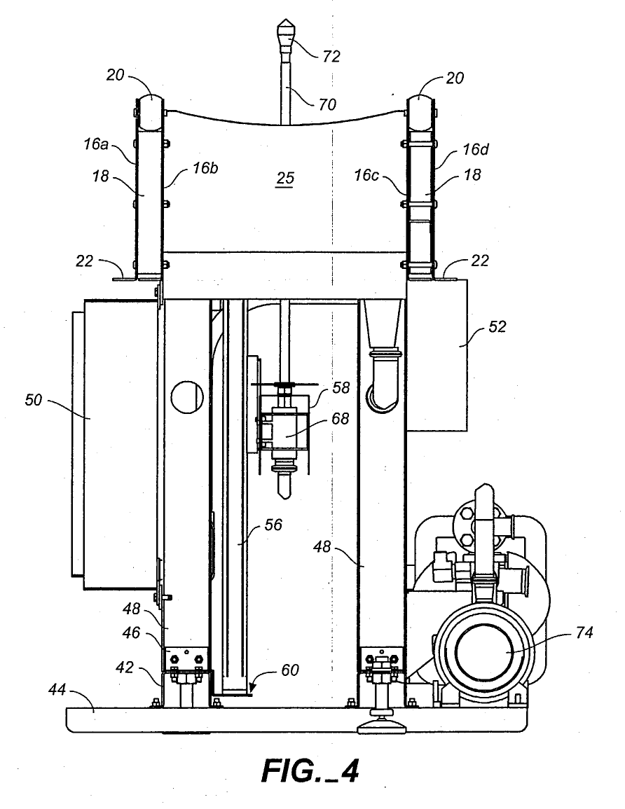

Referring to FIGS. 1 through, wherein like reference numerals refer to like components in the various views, FIG. 1 is a perspective view of the wine barrel washing apparatus of the present invention, while FIG. 2 is a top view thereof. FIG. 3 is a front view in elevation of the inventive apparatus; and FIG. 4 is a right side view in elevation of the improved wine barrel cleaner of the present invention. These views collectively show that the improved wine barrel cleaning apparatus of the present invention, generally denominated 10 herein, comprises a base portion 12 and a top portion 14. The top portion 14 comprises at least four identical roller support plates 16a-d, two sets of two on each side of the machine, each set spaced apart with four identical spacer channels 18, drilled with clearance holes, and aligned, and secured by nut-and-bolt or clevis-and-cotter pin assemblies to accommodate eight urethane rollers 20. The roller support plates thus attach to an adjacent support plate through the spacer channels. The two outboard roller support plates 16a, 16d, have an outwardly disposed flange 22 for supporting wine barrel racks.

Two sinks 24, 26 are formed by sink ends 28 welded or otherwise securely connected to a sink wrapper 30. Also welded to the sink wrapper are a drain reducer 32 and a wash tube seal assembly 34, which selectively seals the drain during washing operations.

The base portion 12 is formed by two identical hat channels 40, which are drilled to accept the screw adjustable leveling feet 42 that the machine rests upon, as well as the two identical forklift channels 44 which, in turn, are drilled to mount both the lees and pressure pumps. The hat channels are also drilled to mount angle clips 46, which secure in place four identical riser channels 48. The riser channels are drilled to mount the electrical enclosure 50 and the pneumatic enclosure 52, as well as the backbone channel 54 and the roller support plates 16. The backbone channel houses threaded studs on the under side, which support either a linear actuator or rodless air cylinder 56 for actuating the cross arm assembly 58. The base of the linear actuator or air cylinder is secured in place by the lower mounting bracket 60, which is also attached to the screw adjustable leg.

The entire structure is formed of stainless steel, and is held together with bolts and nuts, which facilitate easy assembly by semi-skilled workers. The electrical enclosure, pneumatic enclosure, pumps, valves, cross arm assembly are all pre-wired and connected by quick connect cord attachments. The drain piping and valves are all pre-welded and connected by sanitary quick clamps or bolted flanges.

When employed wine barrels are transported on their storage racks (also known as pallets or cradles) to the wash site using a forklift. While remaining on their storage racks the wine barrels are lowered onto the top of the machine. As the rack is lowered over the roller assembly the barrels are lifted off the rack by the rollers and the downward motion of the rack. The forklift is then withdrawn, and the rack remains resting on the roller assembly. Four rollers support each of two barrels horizontally. The operator then grasps each barrel and rotates them manually until the bunghole is situated directly above, and in line with, the wash head. At this point, if the barrels contain wine, or lees (solid residue left after fermentation) it will be forced by gravity to run out of the barrel into a sink 24, 26. The operator then has the option to collect and separate these by products by turning on the “lees pump”62. The lees pump is an air driven diaphragm pump that sucks the wine and lees from the sink through the sink drain lines 64 and air actuated butterfly valves 66.

Once the wine and lees have been collected, the operator pushes a button on the PLC or microprocessor (not shown) housed within the electrical enclosure 50, which causes the motorized linear actuator or rodless air cylinder 56 to raise the cross arm assembly 58. The cross arm assembly houses two rotating unions 68 driven and rotated by electrical motors (not shown), which in turn, support the wash tubes 70 and finally the wash heads 72. The entire assembly is driven upward to the point where the wash heads stop just below the bilge of the barrels (which action is controlled by a limit switch). Raising the wash heads automatically turns off the lees pump, and repositions the drain valves to direct the rinse water to a separate drain. Another push of the “heads up” push button drives the wash head into the barrel through the bunghole. When the “bung level limit switch” (not shown) is reached the PLC or microprocessor (which controls the entire machine) begins the wash cycle by turning on the pressure pump 74 and opening the hot water diaphragm valve 76, and energizing the wash tube turn motors (not shown). The wash head sprays the inside of the bunghole area at close proximity for a time period set on an adjustable timer (not shown). At the completion of that time sequence the microprocessor drives the wash heads up into the center of the barrel for the remainder of the hot, and cold wash cycles. Adjustable timers mounted in the electrical enclosure control the hot and cold cycle duration. At the completion of the wash sequence the wash heads are automatically lowered, and the way is clear for removal of the rack of clean barrels.

The wash head is streamlined to aid in the entrance and withdrawal from the barrel. It has three spray tips that are angled to cover a spread of 155 degrees without any gaps in the spray pattern. The spray tips flow a total of six gallons per minute at 120 psi, although the system can be designed to handle pressures up to and exceeding 2,000 psi. The motors rotate the wash heads at 20 rpm and can be varied to work optimally with the pressures employed. These factors, combined with a water temperature of at least 160 degrees F. (88.9° C.), are the optimum elements to achieve clean barrels in a minimum amount of time.

In its most essential aspect, the invention may be characterized as a wine barrel washing apparatus, comprising a base portion (12) having a plurality of horizontal and vertical support members; a top portion (14) mounted on said base portion; wherein said top portion comprises a plurality of spaced apart roller support plates (16), and a plurality of sinks (24/26) disposed within said top portion, each of said sinks having a drain with sink drain lines in fluid communication therewith; a plurality of wash tubes (70), each of said tubes having a wash head (72) for insertion into a wine barrel through the wine barrel bung hole; a source of pressurized water in fluid communication with said wash tubes; wash tube elevation means (56) for raising and lowering said wash tubes, said elevation means mounted on said base portion; wash tube rotating means (not shown) for rotating said wash heads, said rotating means mounted on said base portion; and programmable logic means (not shown) for controlling a barrel washing cycle.

It is a characteristic of the machine design is that it is not possible to construct it with fewer components or less material while having it meet all of the performance and functional criteria. The entire machine is a cohesive unit in which each component is both structural and functional. In all prior examples the roller assemblies have been add on features and not functioning structural members of the unit; nor have the electrical and pneumatic enclosures been utilized for their structural shear strength as well as their primary function.

The barrel washing machine disclosed herein is a unique and efficient design that will withstand the abuse of constant use. It will clean barrels with a uniform consistency while consuming a minimum amount of water and energy. It is portable and stable. It is easy to assemble and maintain. It is safe to use and is adaptable to a world market.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. For instance, it would be obvious to one having skill in the art to provide a wine barrel washing apparatus of the type disclosed herein having a roller assembly and wash head arrangement adapted for cleaning four wine barrels on a four barrel rack.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A wine barrel washing apparatus, comprising:
a base portion (12) having a plurality of horizontal and vertical support members;
a top portion (14) mounted on said base portion;
wherein said top portion comprises a plurality of spaced apart roller support plates (16), and a plurality of sinks (24/26) disposed within said top portion, each of said sinks having a drain with sink drain lines in fluid communication therewith;
a plurality of wash tubes (70), each of said tubes having a wash head (72) for insertion into a wine barrel through the wine barrel bung hole;
a source of pressurized water in fluid communication with said wash tubes;
wash tube elevation means (56) for raising and lowering said wash tubes, said elevation means mounted on said base portion;
wash tube rotating means for rotating said wash heads, said rotating means mounted on said base portion; and
programmable logic means for controlling a barrel washing cycle.

2. The wine barrel washing apparatus of claim 1, wherein said programmable logic means is a programmable logic controller.

3. The wine barrel washing apparatus of claim 1, wherein said programmable logic means is a microprocessor.

4. The wine barrel washing apparatus of claim 1, wherein said programmable logic means is mounted on said bottom portion of said apparatus.

5. The wine barrel washing apparatus of claim 1, wherein said wash tube elevation means comprises a linear actuator.

6. The wine barrel washing apparatus of claim 1, wherein said wash tube elevation means comprises a rodless air cylinder.

7. The wine barrel washing apparatus of claim 1, wherein said wash tube rotating means comprises an electric motor.

8. The wine barrel washing apparatus of claim 1, further including a lees pump in fluid communication with said wash tubes.
